(19) United States
(12) Patent Application Publication
(10) Pub. No.: US 2026/0319307 A1
(43) Pub. Date: Oct. 15, 2026

(54) VEHICULAR INTERIOR REARVIEW MIRROR ASSEMBLY WITH EC CONNECTION VIA SOCKET ELEMENT

(71) Applicant: Magna Mirrors of America, Inc., Holland, MI (US)

(72) Inventors: John T. Uken, Jenison, MI (US); Jeffrey R. Westbrook, Lowell, MI (US)

(21) Appl. No.: 19/467,915

(22) Filed: Feb. 3, 2026

Related U.S. Application Data
(60) Provisional application No. 63/757,853, filed on Feb. 13, 2025.

(51) Int. Cl. G02F 1/155; B60R 1/04; G02F 1/1333

(52) U.S. Cl. CPC G02F 1/155; B60R 1/04; G02F 1/133331; G02F 2203/02

(57) ABSTRACT

A vehicular interior electrochromic rearview mirror assembly includes a mirror head that includes a socket that receives a ball member of mounting structure to adjustably mount the mirror head to mounting structure at an interior portion of an interior cabin of the vehicle. The mirror head accommodates an electrochromic mirror reflective element that is attached at an attachment portion of the mirror head. The socket includes an electrical connector having connector portions that electrically connect to electrically conductive contacts at a side of the electrochromic mirror reflective element when the electrochromic mirror reflective element is attached at the socket via each connector portion being biased toward and engaging the respective electrically conductive contact. The electrical connector of the socket is electrically connected to a wire harness of the vehicle for at least in part controlling operation of the electrochromic mirror reflective element.

### CROSS REFERENCE TO RELATED APPLICATION

The present application claims the filing benefits of U.S. provisional application Ser. No. 63/757,853, filed Feb. 13, 2025, which is hereby incorporated herein by reference in its entirety.

### FIELD OF THE INVENTION

The present invention relates generally to the field of interior rearview mirror assemblies for vehicles.

### BACKGROUND OF THE INVENTION

It is known to provide a mirror assembly that is adjustably mounted to an interior portion of a vehicle, such as via a double ball pivot or joint mounting configuration where the mirror casing and reflective element are adjusted relative to the interior portion of the vehicle by pivotal movement about the double ball pivot configuration. The mirror casing and reflective element are pivotable about either or both of the ball pivot joints by a user that is adjusting a rearward field of view of the reflective element.

### SUMMARY OF THE INVENTION

An interior rearview mirror assembly includes a mirror head adjustable relative to mounting structure. The mounting structure is configured to mount the vehicular electrochromic interior rearview mirror assembly at an interior portion of an interior cabin of a vehicle. The mirror head includes a socket and, with the mirror assembly mounted at the interior portion of the interior cabin of the vehicle, the socket receives a ball member of the mounting structure to adjustably mount the mirror head relative to the mounting structure. The mirror head accommodates an electrochromic mirror reflective element. With the mirror assembly mounted at the interior portion of the interior cabin of the vehicle, the mirror head is adjustable by a driver of the vehicle to set a rearward view for the driver. The electrochromic mirror reflective element includes (i) a front glass substrate having a first surface and a second surface and (ii) a rear glass substrate having a third surface and a fourth surface. A transparent electrically conductive film or layer is disposed at the second surface of the front glass substrate and an electrically conductive film or layer is disposed at the third surface of the rear glass substrate. An electrochromic medium is disposed between the front glass substrate and the rear glass substrate and contacts the transparent electrically conductive film at the second surface of the front glass substrate and the electrically conductive film at the third surface of the rear glass substrate. Electrically conductive contacts at a rear side of the electrochromic mirror reflective element are in electrical connection with respective ones of the transparent electrically conductive film at the second surface of the front glass substrate of the electrochromic mirror reflective element and the electrically conductive film at the third surface of the rear glass substrate of the electrochromic mirror reflective element. The mirror reflective element is attached at an attachment portion of the mirror head. An electrical connector is disposed between the rear side of the electrochromic mirror reflective element and the attachment portion of the mirror head. Respective connector portions of the electrical connector electrically connect to respective ones of the electrically conductive contacts at the rear side of the electrochromic mirror reflective element. Electrical connection of the electrical connector to the respective electrically conductive contacts at the rear side of the electrochromic mirror reflective element is made via each connector portion of the electrical connector, as the electrochromic mirror reflective element is attached at the attachment portion of the mirror head, engaging the respective electrically conductive contact and flexing and being biased toward the respective electrically conductive contact to maintain electrical connection with the electrically conductive contact. Circuitry for controlling dimming of the electrochromic mirror reflective element is disposed remote from the vehicular electrochromic interior rearview mirror assembly. The electrical connector is electrically connected to a connector of the socket. With the vehicular electrochromic interior rearview mirror assembly mounted at the interior portion of the interior cabin of the vehicle and with the ball member of the mounting structure received in the socket of the mirror head, the connector is electrically connected to a wire harness of the vehicle to electrically connect to the circuitry for controlling dimming of the electrochromic mirror reflective element.

These and other objects, advantages, purposes and features of the present invention will become apparent upon review of the following specification in conjunction with the drawings.

### BRIEF DESCRIPTION OF THE DRAWINGS

FIG. 1 is a perspective view of an interior rearview mirror assembly;

FIG. 2 is a sectional view of the mirror reflective element of the interior rearview mirror assembly;

FIG. 3 is an exploded view of the interior rearview mirror assembly;

FIG. 4 is a perspective view of a mounting base of the interior rearview mirror assembly that includes a socket;

FIG. 5 is a perspective view of an insert molded clip of the mounting base of FIG. 4, with example dimensions;

FIGS. 6A-6H are views of the mounting base of FIG. 4 with example dimensions;

FIGS. 7A-7D are views of a mounting base of the interior rearview mirror assembly that includes a ball member, with example dimensions;

FIG. 8 includes views of a wrap spring of the interior rearview mirror assembly, with example dimensions;

FIGS. 9A-9E are views of a two-ball member mounting arm of the interior rearview mirror assembly, with example dimensions;

FIGS. 10A-10E are views of a mirror casing of the interior rearview mirror assembly, with example dimensions;

FIGS. 11A and 11B are views of a mirror reflective element of the interior rearview mirror assembly, with example dimensions;

FIGS. 12A-12D are views of an adhesive element of the interior rearview mirror assembly, with example dimensions;

FIGS. 13A and 13B are views of a lead-frame of the interior rearview mirror assembly, with example dimensions; and

FIG. 14 includes views of an electrical connector of the interior rearview mirror assembly including the lead-frame, with example dimensions.

### DESCRIPTION OF THE PREFERRED EMBODIMENTS

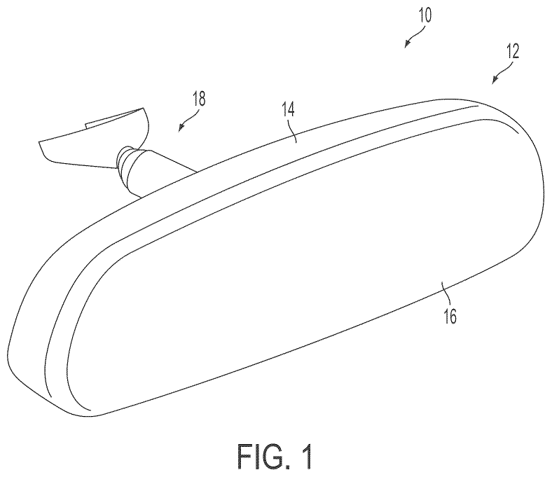

Referring now to the drawings and the illustrative embodiments depicted therein, an interior rearview mirror assembly 10 for a vehicle includes a mirror head 12 having a casing 14 and a reflective element 16 positioned at a front portion of the casing 14 (FIG. 1). In the illustrated example, the mirror assembly 10 is configured to be adjustably mounted to an interior portion of a vehicle (such as to an interior or in-cabin surface of a vehicle windshield or a headliner of the vehicle or the like) via a mounting base or mounting structure or mounting configuration or assembly 18. The mirror reflective element comprises a variable reflectance mirror reflective element that varies its reflectance responsive to electrical current applied to electrically conductive coatings or films or layers of the reflective element. As discussed below, the mirror assembly provides a thin or substantially reduced size or reduced profile mirror head with an auto-dimming mirror reflective element. Electrical connectors for electrically connecting the electrochromic mirror reflective element 16 to a wire harness of the vehicle are integrated with a socket of the mounting configuration 18, resulting in a quicker and simpler assembly and installation process and a thinner overall construction of the mirror assembly.

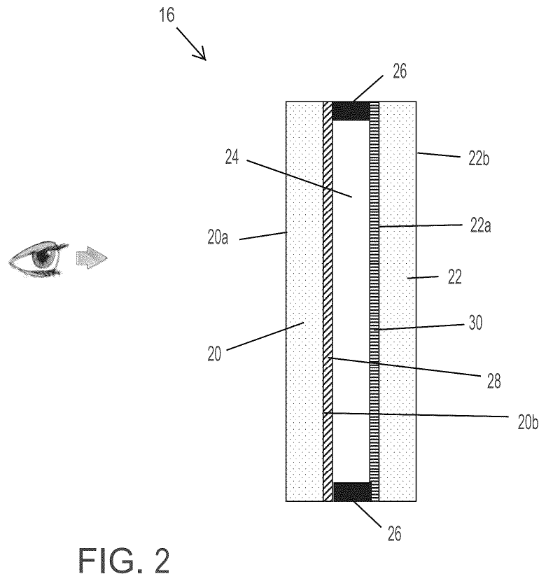

In the illustrated embodiment, and as shown in FIG. 2, the mirror reflective element 16 comprises a laminate construction variable reflectance electro-optic (such as electrochromic) reflective element assembly having a front substrate 20 and a rear substrate 22 with an electro-optic medium 24 (such as electrochromic medium) sandwiched therebetween and bounded by a main seal or perimeter seal 26. As shown in FIG. 2, the front substrate 20 has a front or first surface 20a (the surface that generally faces the driver of a vehicle when the mirror assembly is normally mounted at the vehicle) and a rear or second surface 20b opposite the front surface 20a, and the rear substrate 22 has a front or third surface 22a and a rear or fourth surface 22b opposite the front surface 22a, with the electro-optic medium 24 disposed between the second surface 20b and the third surface 22a and bounded by the perimeter seal 26 of the reflective element. The second surface 20b of the front glass substrate 20 has a transparent conductive coating 28 established thereat (such as an indium tin oxide (ITO) layer, or a doped tin oxide layer or any other transparent electrically semi-conductive layer or coating or the like (such as indium cerium oxide (ICO), indium tungsten oxide (IWO), or indium oxide (IO) layers or the like or a zinc oxide layer or coating, or a zinc oxide coating or the like doped with aluminum or other metallic materials, such as silver or gold or the like, or other oxides doped with a suitable metallic material or the like, or such as disclosed in U.S. Pat. No. 7,274,501, which is hereby incorporated herein by reference in its entirety), while the third surface 22a of the rear glass substrate 22 has a metallic reflector coating 30 (or multiple layers or coatings) established thereat. The front or third surface 22a of the rear substrate 22 may include one or more transparent semi-conductive layers (such as an ITO layer or the like), and one or more metallic electrically conductive layers (such as a layer of silver, aluminum, chromium or the like or an alloy thereof), and may include multiple layers such as disclosed in U.S. Pat. Nos. 7,274,501; 7,184,190 and/or 7,255,451, which are hereby incorporated herein by reference in their entireties. The mirror reflector may comprise any suitable coatings or layers, such as a transflective coating or layer, such as described in U.S. Pat. Nos. 7,626,749; 7,274,501; 7,255,451; 7,195,381; 7,184,190; 6,690,268; 5,140,455; 5,151,816; 6,178,034; 6,154,306; 6,002,511; 5,567,360; 5,525,264; 5,610,756; 5,406,414; 5,253,109; 5,076,673; 5,073,012; 5,115,346; 5,724,187; 5,668,663; 5,910,854; 5,142,407 and/or 4,712,879, which are hereby incorporated herein by reference in their entireties, disposed at the front surface of the rear substrate (commonly referred to as the third surface of the reflective element) and opposing the electro-optic medium, such as an electrochromic medium disposed between the front and rear substrates and bounded by the perimeter seal (but optionally, the mirror reflector could be disposed at the rear surface of the rear substrate (commonly referred to as the fourth surface of the reflective element).

The third surface 22a defines the active EC area or surface of the rear substrate within the perimeter seal 26. The coated third surface 22a may also be coated to define a tab-out region (such as by utilizing aspects of the mirror assemblies described in U.S. Pat. No. 7,274,501; 7,184,190 and/or 7,255,451, which are hereby incorporated herein by reference in their entireties) for providing electrical connection of the conductive layers to an electrical clip of connector or bus-bar, such as the types described in U.S. Pat. Nos. 5,066,112 and 6,449,082, which are hereby incorporated herein by reference in their entireties.

The mirror assembly may comprise a frameless mirror assembly, where the front glass substrate may have an exposed rounded perimeter glass edge that provides a curved transition from the planar first surface of the front glass substrate to an outer less curved surface of the mirror casing (such as by utilizing aspects of the mirror assemblies described in U.S. Pat. Nos. 9,827,913; 9,174,578; 8,508,831; 8,730,553; 9,598,016 and/or 9,346,403, which are hereby incorporated herein by reference in their entireties). Optionally, the mirror assembly may include a casing portion that circumscribes the perimeter glass edge of the front glass substrate and provides the curved transition from the planar first surface of the front glass substrate to an outer less curved surface of the mirror casing, with the mirror casing portion not encroaching onto or overlapping the planar front or first surface of the front glass substrate (such as by utilizing aspects of the mirror assemblies described in U.S. Pat. Nos. 7,184,190; 7,274,501; 7,255,451; 7,289,037; 7,360,932; 7,626,749; 8,049,640; 8,277,059 and/or 8,529,108, which are hereby incorporated herein by reference in their entireties).

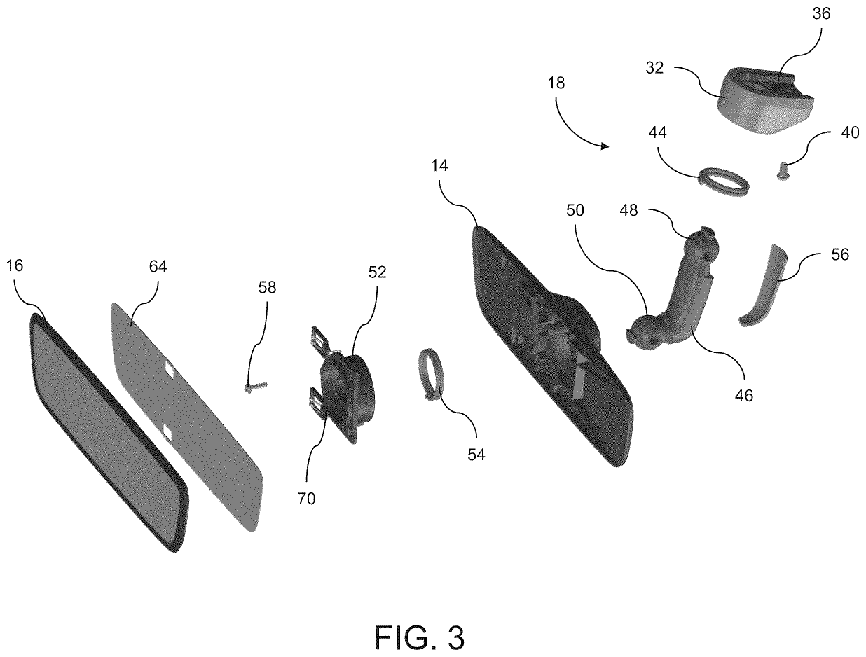

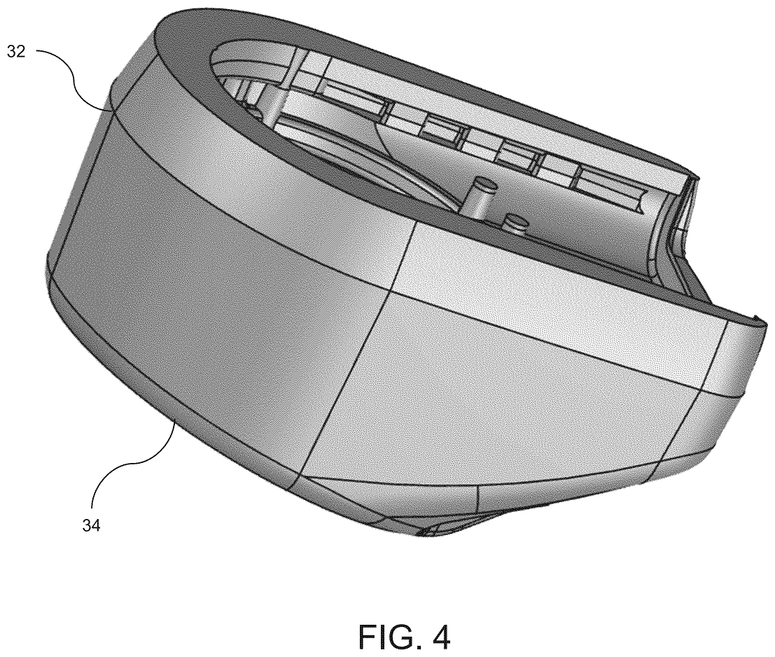

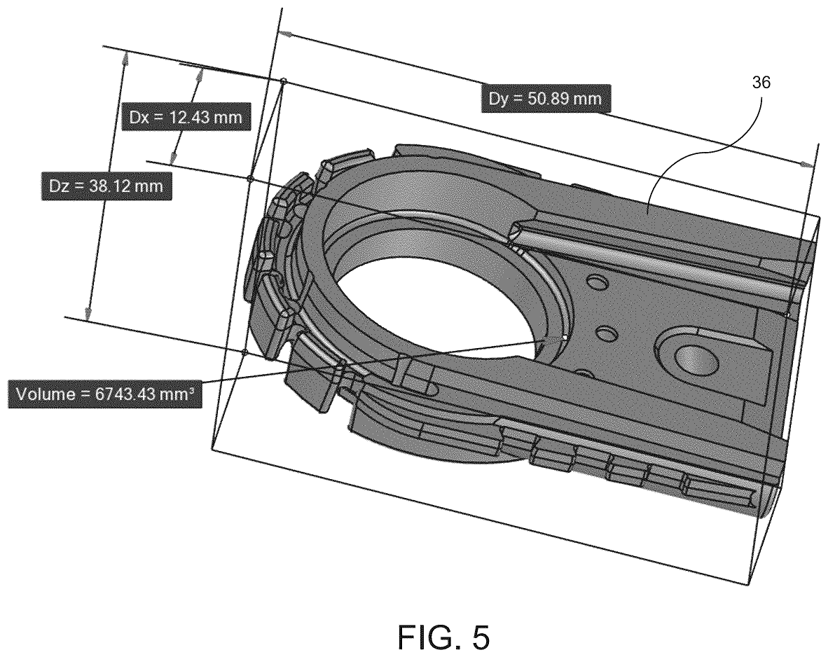

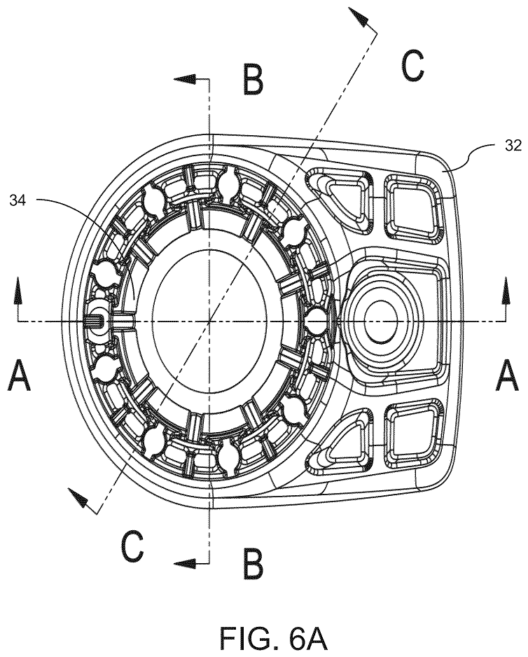

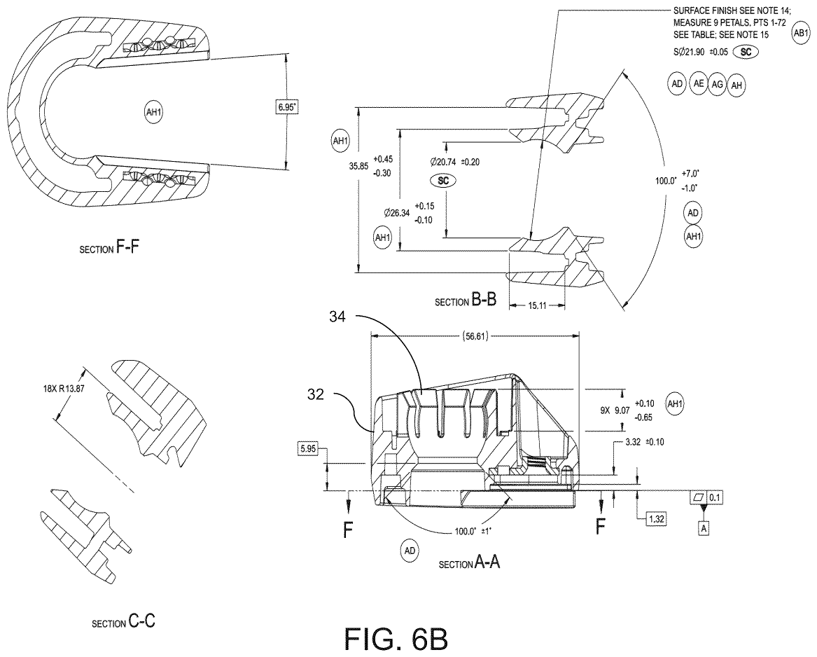

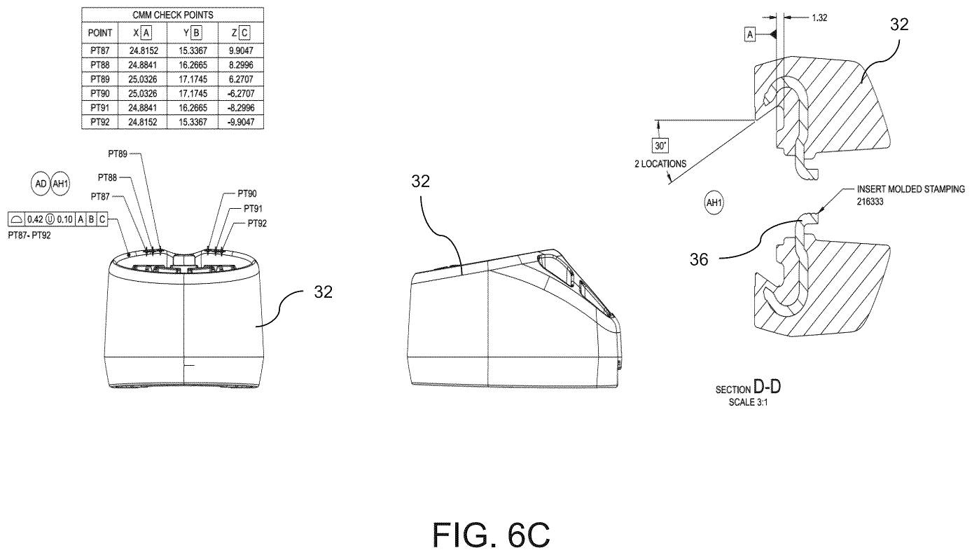

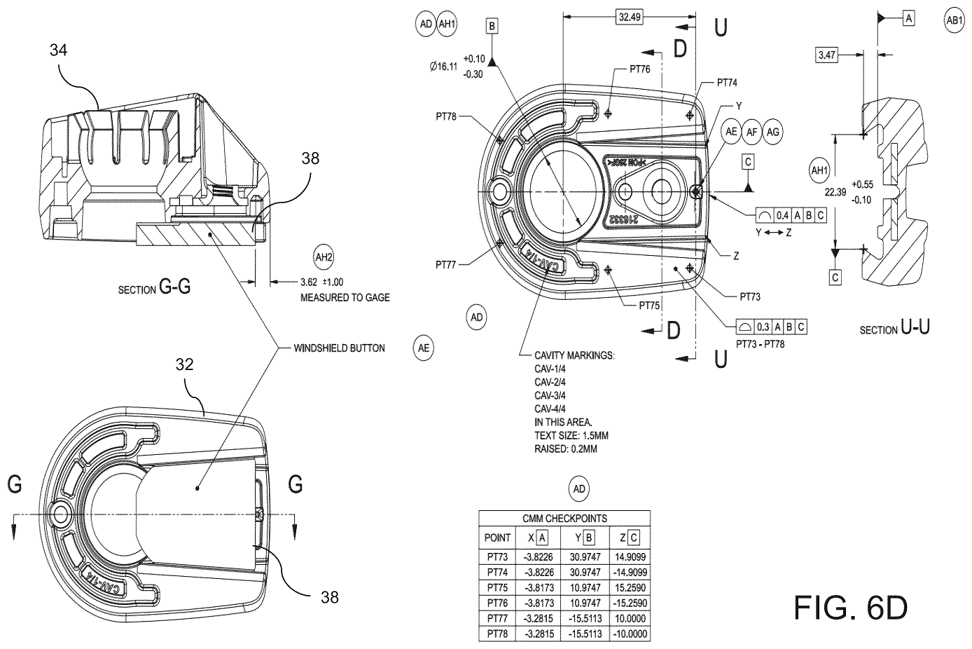

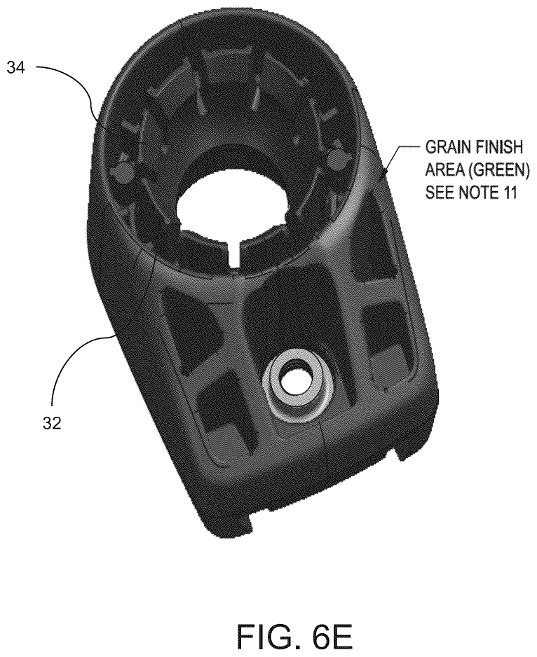

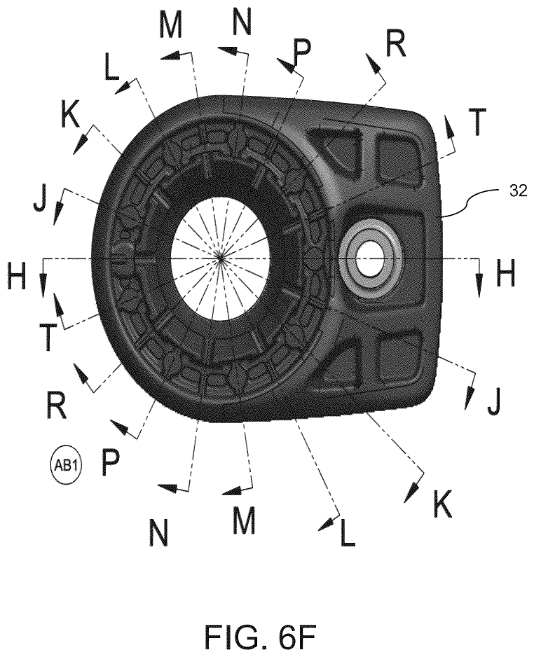

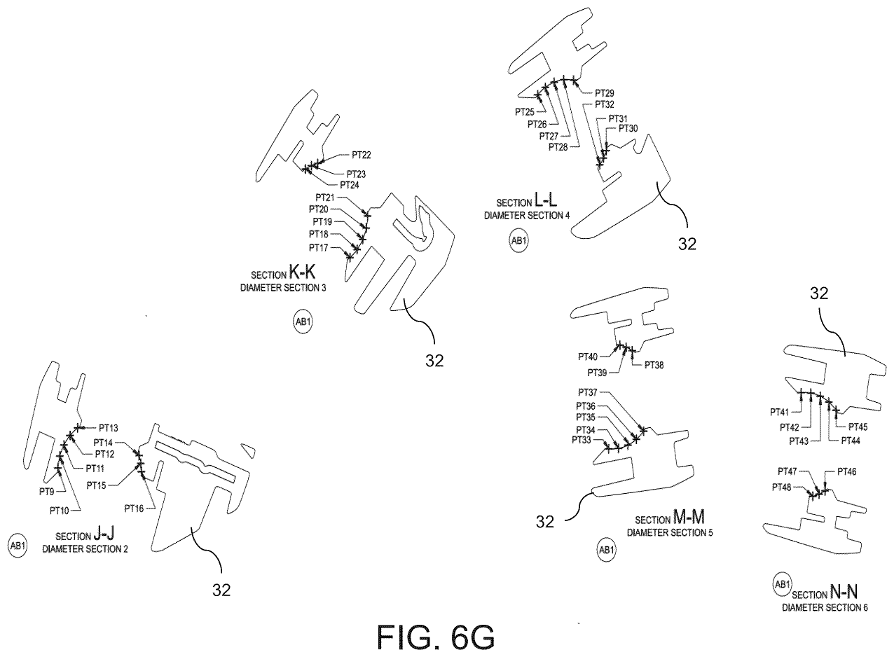

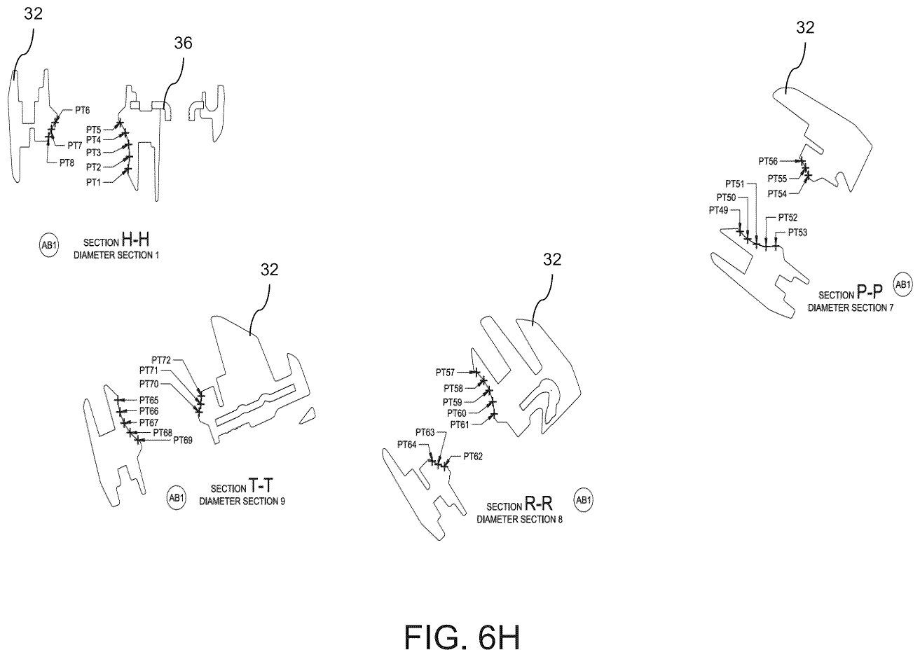

Referring to FIGS. 3-6H, the mounting structure 18 comprises a ball and socket construction, with a mounting base or stay 32 having a socket 34. The stay 32 may mount at the interior of the vehicle, such as directly to the windshield or headliner or another component (such as an overhead console or windshield mounted console), via any suitable means such as an adhesive or fastener. In the illustrated example, the stay 32 mounts at the vehicle via a base or mount 36 that slidably receives a wedge or button 38 disposed at the interior portion of the vehicle, such as a dovetail wedge. The wedge 38 may be adhesively disposed at the interior portion of the vehicle. The stay 32 and the mount 36 may receive a set screw 40 that extends through a tapped screw hole of the stay 32 and mount 36 and engages the wedge 38 to secure the stay 32 at the wedge 38 and the interior portion of the vehicle. The mount 36 may be a metallic component insert molded with the socket 34. For example, the mount 36 may be a zinc die cast component so that no powder coating is required. The mount 36 may be at least partially exposed at an upper portion of the stay 32 for engaging the wedge 38 directly or the mount 36 may be insert molded within the plastic stay 32 to provide structural support for the portion of the stay 32 engaging the wedge 38. Insert molding the dovetail shaped spring may improve consistency as removing the plastic in the mounting region of the button interface helps reduce variation and increases reliability of the joint.

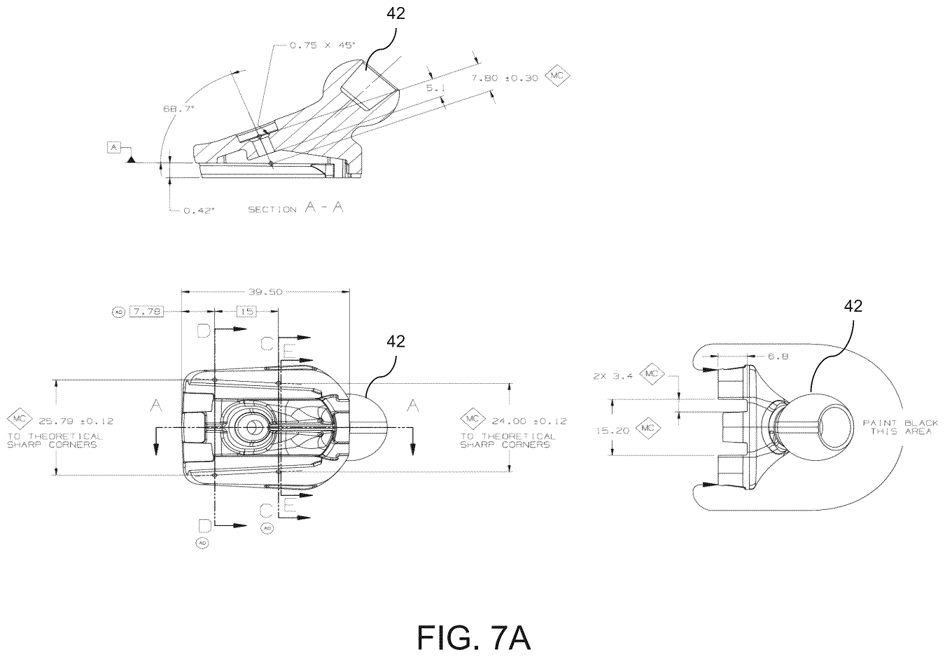

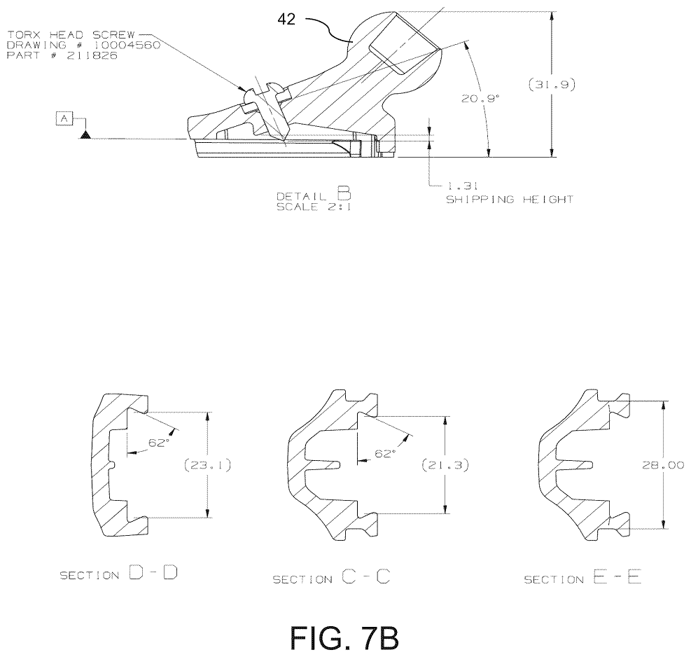

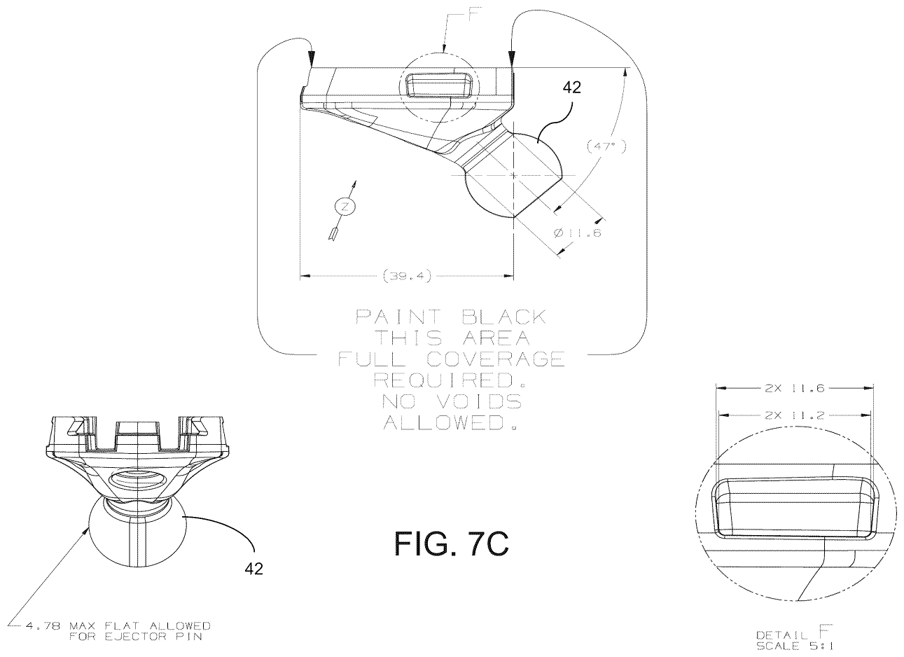

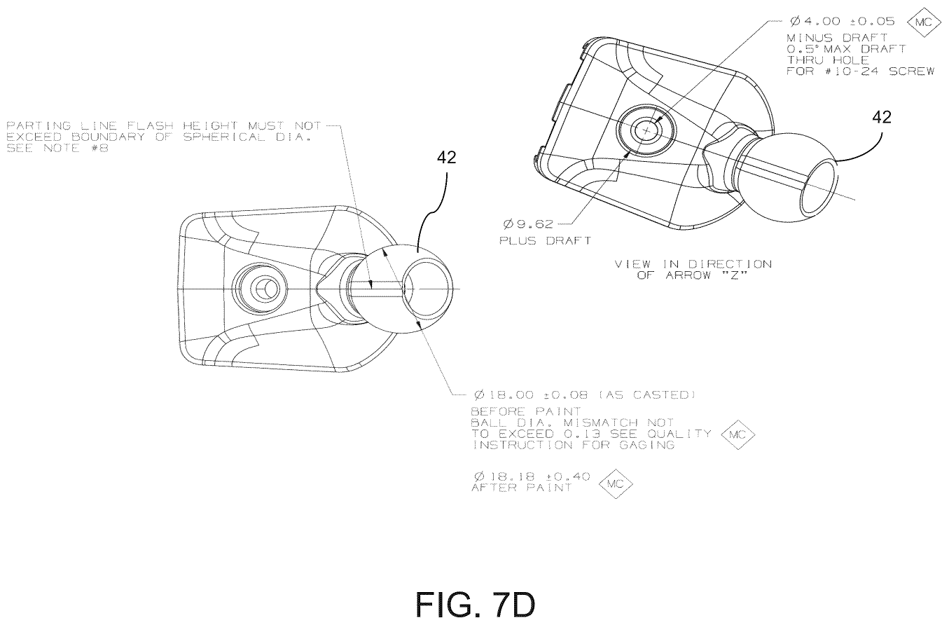

In some examples, and such as shown in FIGS. 7A-7D, the stay 32 may include a ball member 42 instead of the socket. The ball member 42 may be received at a socket of the mirror head and/or a socket of a mounting arm that attaches to the mirror head.

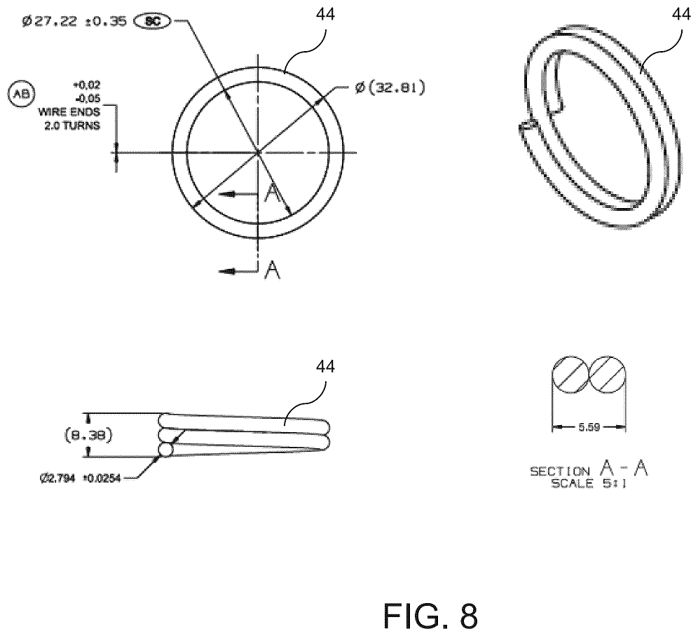

In the illustrated example of FIG. 3, a socket spring ring 44 (FIG. 8), or other suitable biasing member, may circumscribe the socket 34 and provide a retaining force to retain a first ball member 48 of a mounting arm 46 of the mounting structure 18 within the socket 34. With the mirror assembly installed at the vehicle, the first ball member 48 at a first end of the mounting arm 46 may be received at the socket 34 of the stay 32 and a second ball member 50 at an opposing second end of the mounting arm 46 may be received at a receiving portion of a socket element 52 at the mirror casing 14. Another socket spring ring 54, or other suitable biasing member, may circumscribe the receiving portion of the socket 52 and provide a retaining force to retain the second ball member 50 within the socket element 52. Thus, the mirror head 12 is pivotable or adjustable relative to the mounting structure 18 about the second ball member 50 and the mounting arm 46 is pivotable or adjustable relative to the stay 32 about the first ball member 48. A cover or panel 56 may attach to the mounting arm 46, such via fasteners or adhesive or via snap-attachment, to provide a Class-A surface at the mounting arm 46.

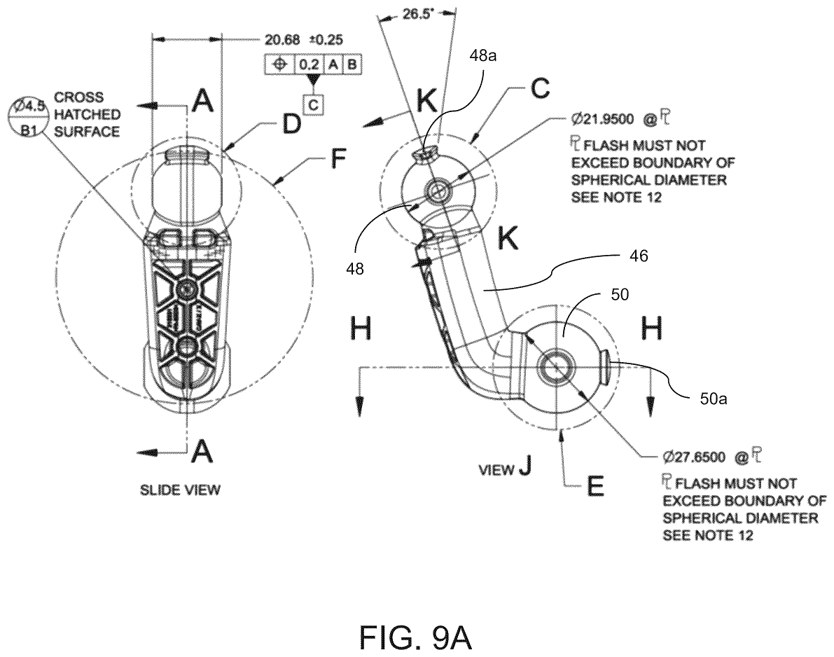

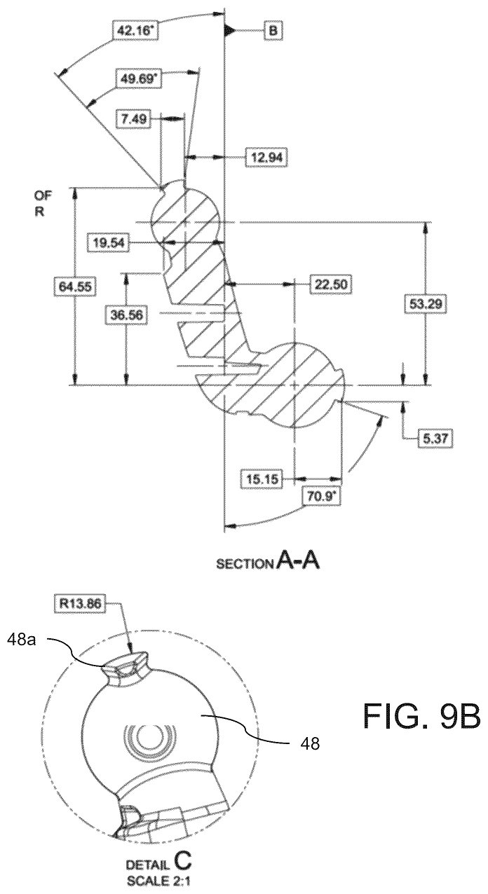

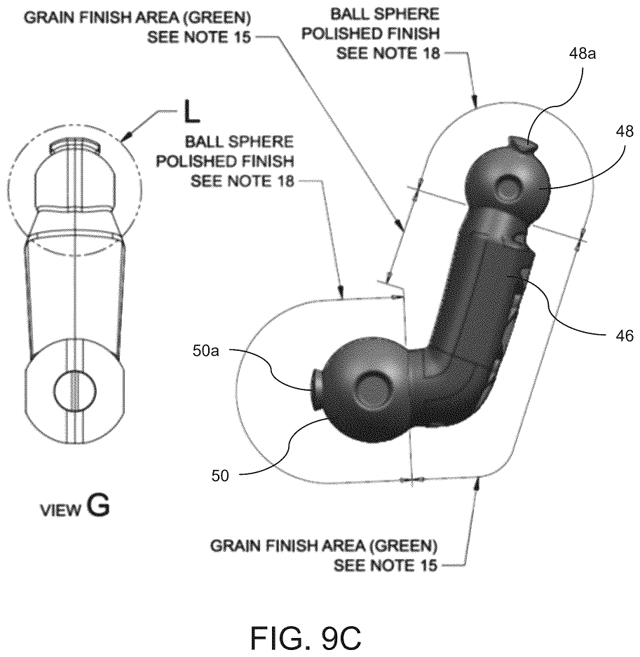

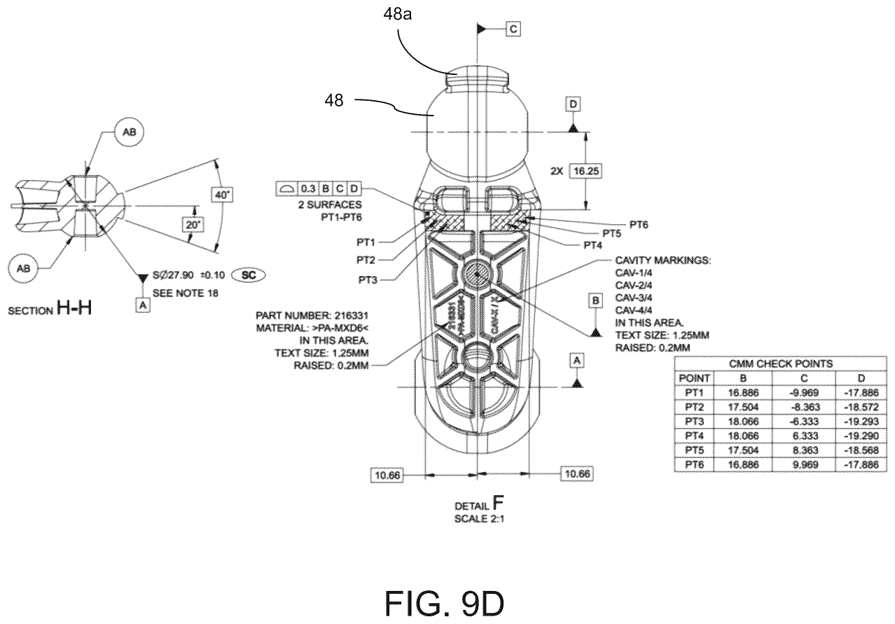

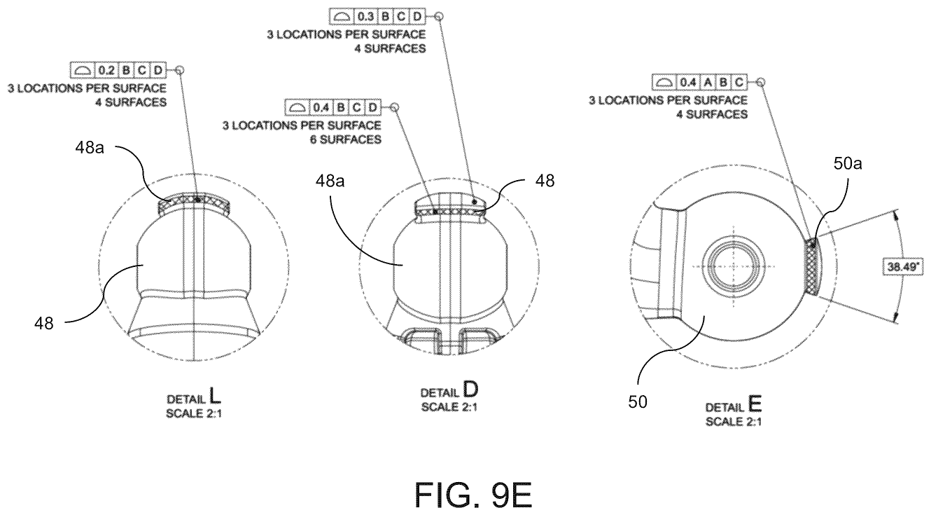

As shown in FIGS. 9A-9E, the first ball member 48 may include an anti-cam-out feature or protrusion 48a and the second ball member 50 may similarly include an anti-cam-out feature or protrusion 50a. The anti-cam-out features 48a, 50a may engage structure at the respective socket 34, 52 to prevent or preclude the mounting arm 46 from detaching from the stay 32 or the mirror head 12. In other words, the anti-cam-out features 48a, 50a engage the structure at the respective socket 34, 52 to prevent the respective ball member 48, 50 from rotating or pivoting within the socket 34, 52 to a point where the ball member 48, 50 could pull out or disengage from the socket 34, 52. That is, the anti-cam-out features 48a, 50a may prevent the mirror head 12 from torquing off the ball joint. Further, respective diameters of the first ball member 48 and the second ball member 50 may be reduced, such as to 28 millimeters or less or 22 millimeters or less, because no wire harness needs to pass through the ball member, as discussed further below. This may result in a smaller socket element 52 at the mirror head 12 and thus a smaller or thinner overall mirror construction.

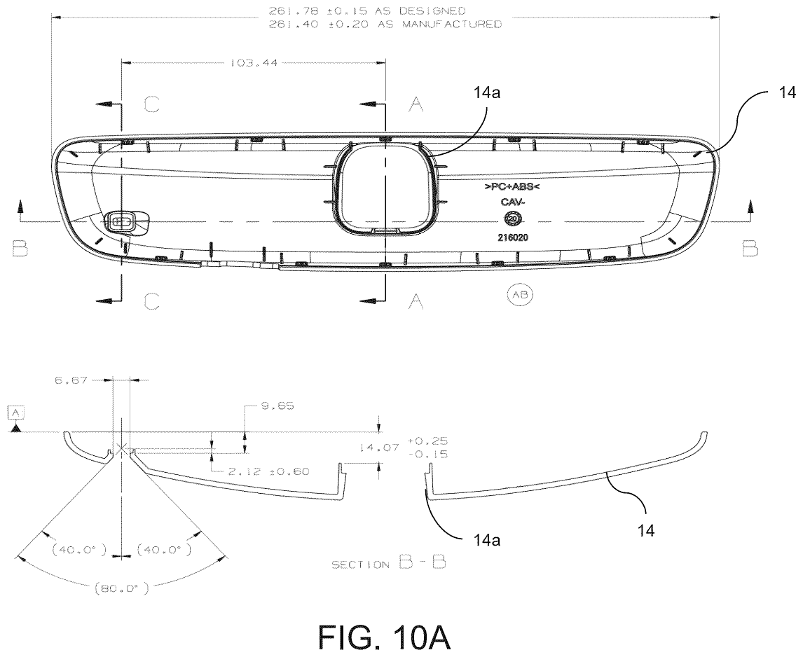

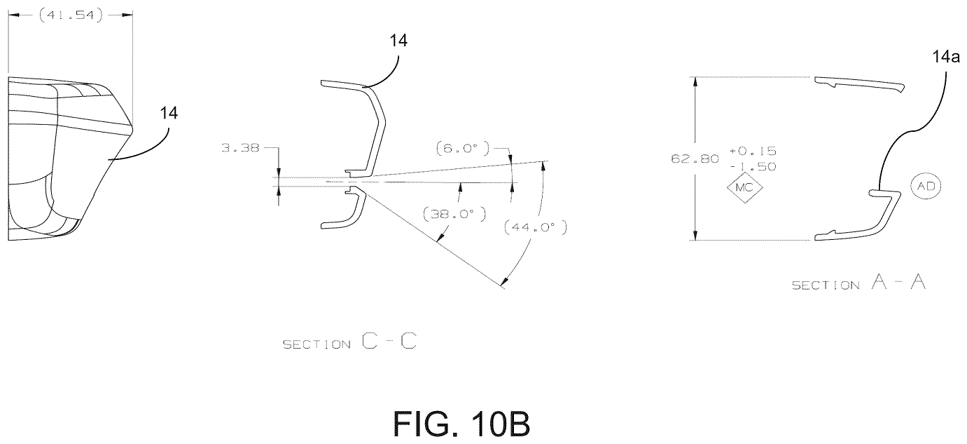

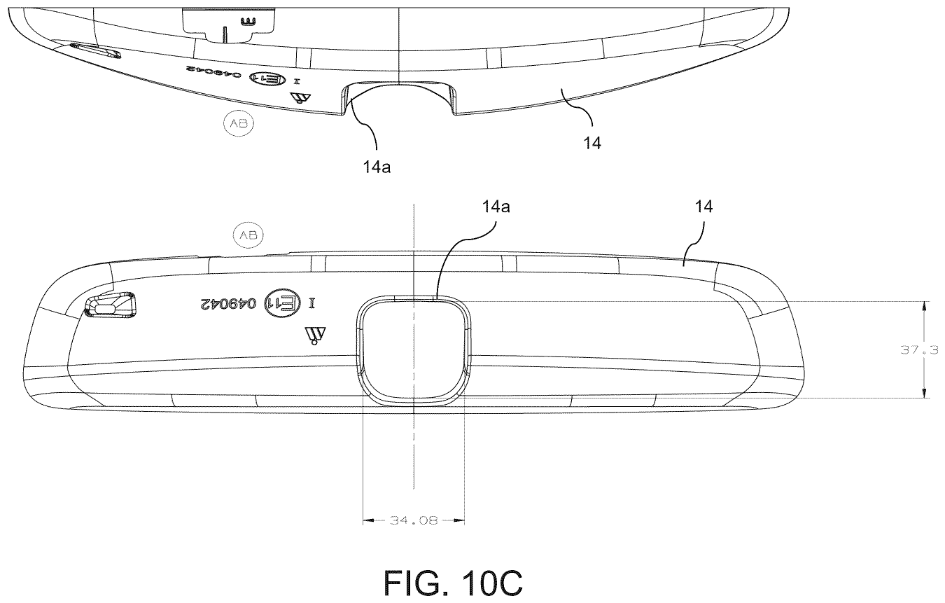

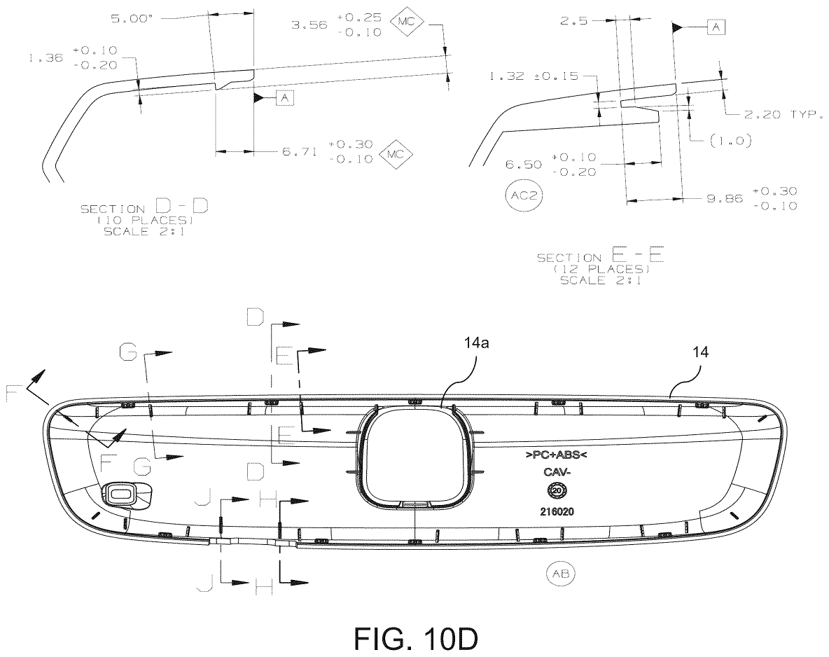

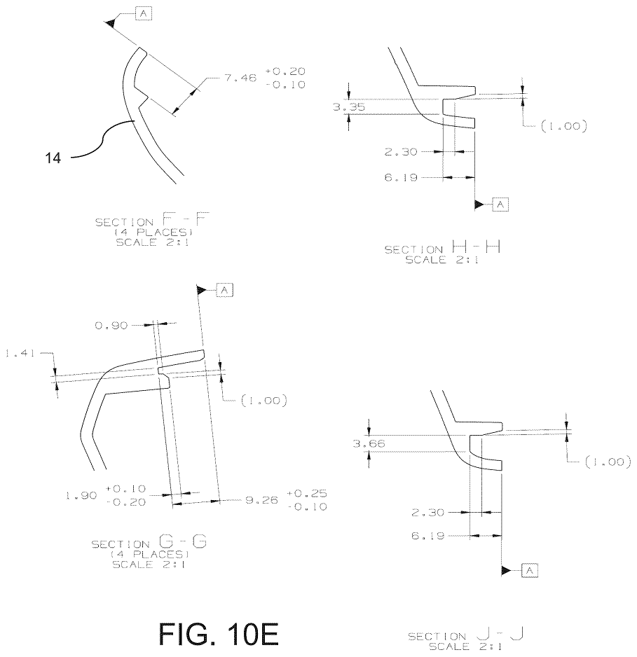

Referring to FIGS. 3 and 10A-10E, the mirror casing 14 includes an aperture or passage 14a so that, with the socket element 52 attached to the mirror casing 14, the receiving portion of the socket element 52 may be accessible through the aperture 14a to receive the second ball member 50. The socket element 52 may attach to an inner surface of the mirror casing 14 in any suitable manner. For example, the socket element 52 may snap attach at the mirror casing 14 and/or the socket element 52 may attach at the mirror casing 14 via screws, adhesive, heat staking, and/or some combination of each. In the illustrated example, the socket element 52 attaches to the mirror casing 14 via two snaps and a screw 58.

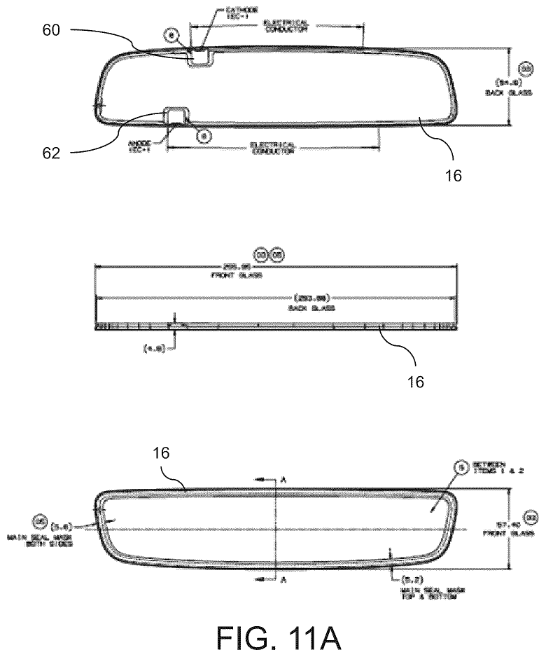

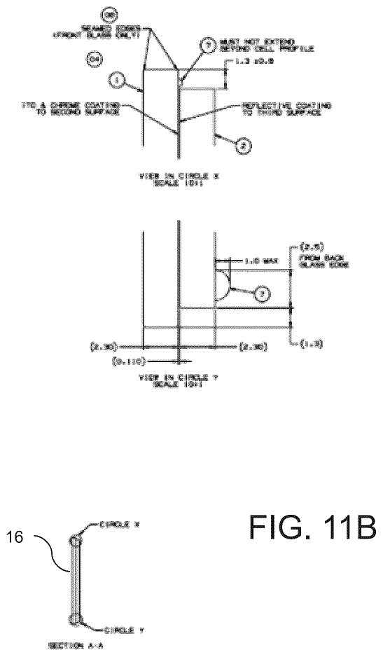

Circuitry for controlling dimming of the electrochromic mirror reflective element 16 may be disposed remote from the mirror assembly and the electrochromic mirror reflective element 16 (FIGS. 11A and 11B) may electrically connect to the vehicle wire harness at the fourth surface 22b of the rear glass substrate 22. For example, the mirror reflective element 16 may include two electrical connectors or tabs 60, 62 in electrical connection with a respective one of the transparent electrically conductive coating at the second surface 20b of the front glass substrate 20 and the electrically conductive coating at the third surface 22a of the rear glass substrate 22. The electrical connector or tab 60 that electrically connects to the electrically conductive coating at the third surface 22a may be disposed at a wraparound coating or busbar that is electrically conductively connected to the electrically conductive coating at the third surface 22a, while the electrical connector or tab 62 that electrically connects to the electrically conductive coating at the second surface 20b may be disposed at an electrically conductive element (e.g., an electrically conductive epoxy) that is electrically conductively connected to the electrically conductive coating at the second surface 20b and that is electrically isolated from the wraparound coating and the electrically conductive coating at the third surface 22a.

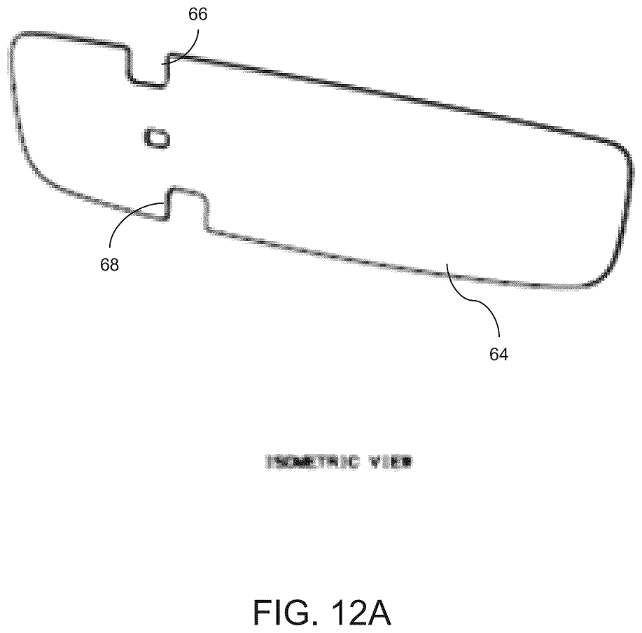

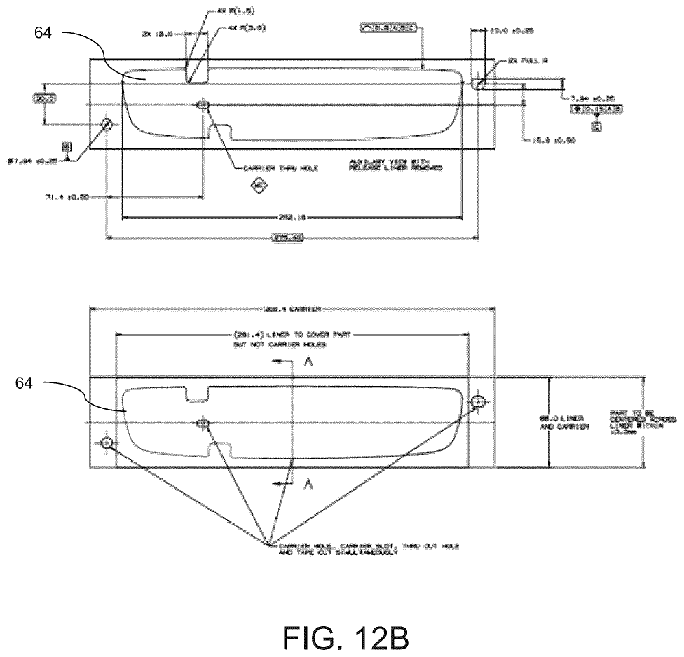

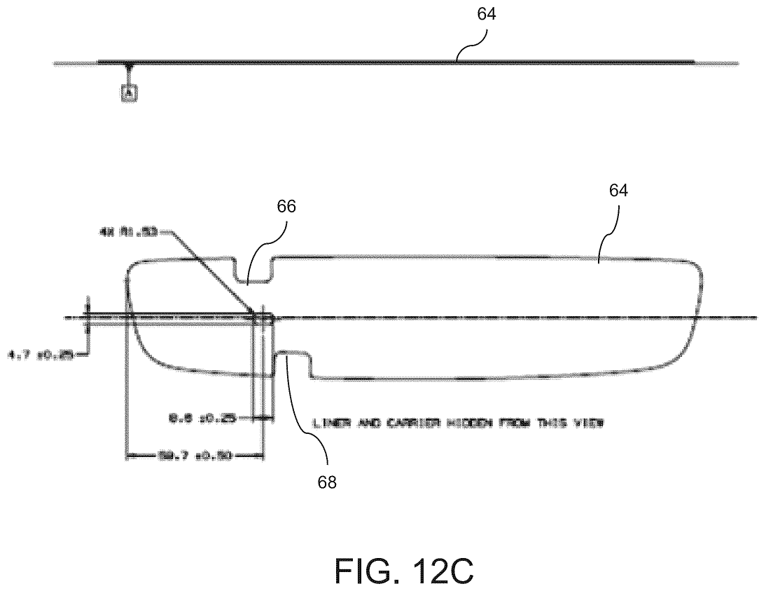

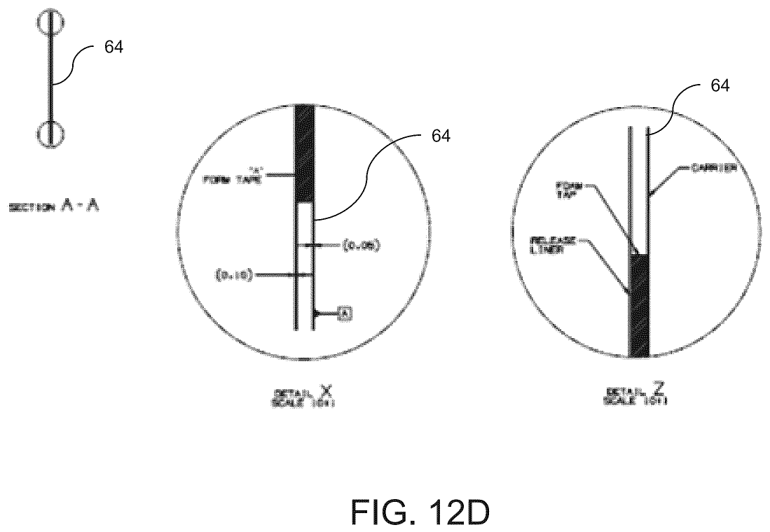

The mirror reflective element 16 may be attached to a mirror back plate and/or an attaching portion or surface of the mirror casing 14 via an adhesive element 64 (FIGS. 12A-12D), such as a layer of adhesive or foam tape or the like, that is disposed between the fourth surface 22b of the mirror reflective element 16 and the attachment surface of the mirror casing 14. That is, the foam tape 64 adhesively attaches at a first side to the mirror casing 14 (or optionally a mirror attachment plate) and at a second side opposite the first side to the mirror reflective element 16. A portion of the first side of the foam tape 64 may adhesively attach to the socket 52 within the mirror head. The foam tape 64 includes one or more apertures or cutout portions or notches to provide access to the electrical connectors 60, 62 at the rear surface of the mirror reflective element 16. In the illustrated example, the foam tape 64 includes a first cutout portion 66 that is aligned with or corresponds to the first electrical connector 60 and a second cutout portion 68 that is aligned with or corresponds to the second electrical connector 62. The mirror reflective element and electrical connectors may utilize aspects of the mirror assemblies described in U.S. Pat. Nos. 11,780,372; 11,766,968; 7,274,501; 7,184,190 and/or 7,255,451, and/or U.S. Pat. Pub. No. US-2025-0074309, and/or International Publication Nos. WO 2025/231198 and/or WO 2026/015777, which are all hereby incorporated herein by reference in their entireties.

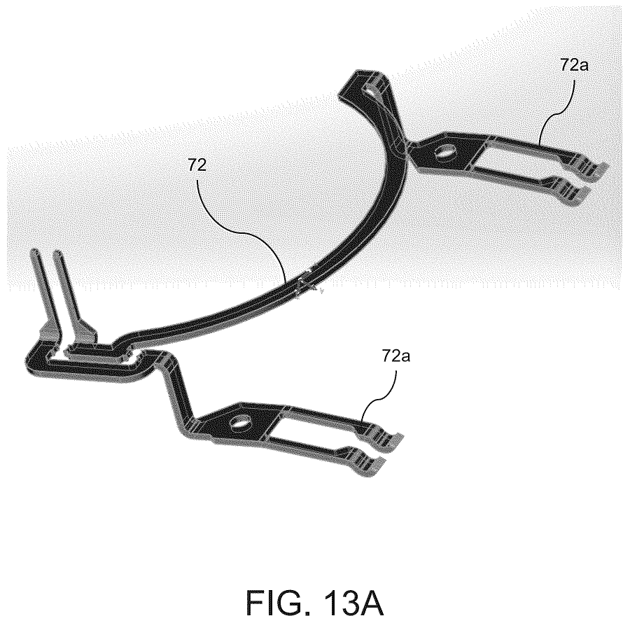

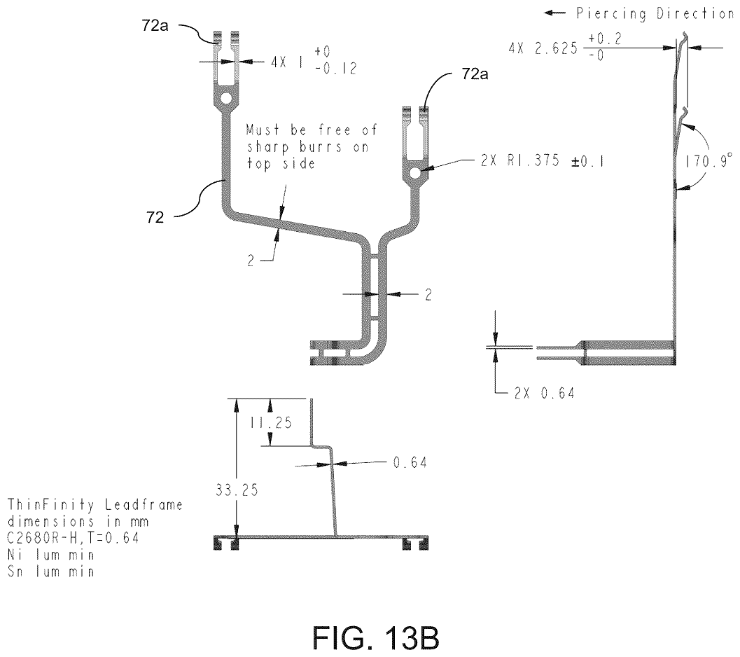

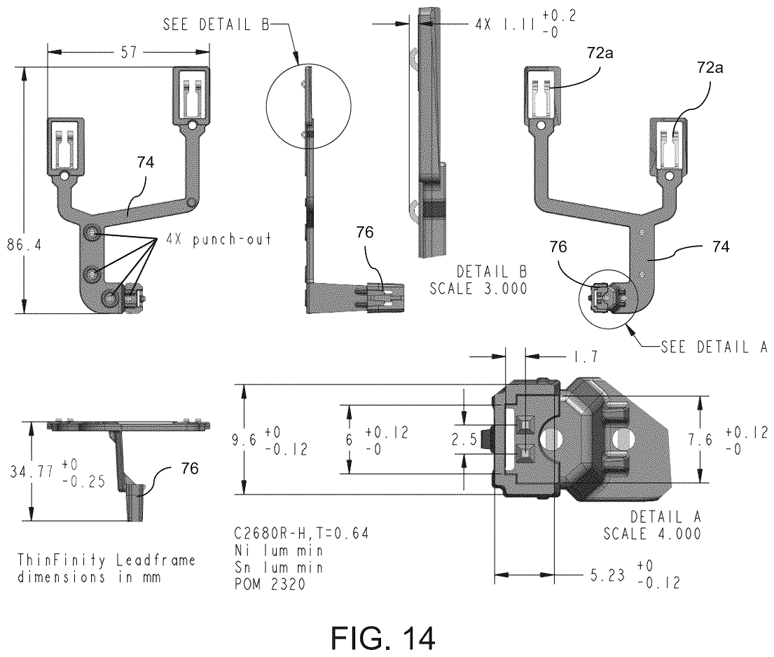

As shown in FIGS. 3, 13A, 13B and 14, the electrical tabs 60, 62 are disposed at the rear surface of the mirror reflective element 16 at the cutout portions 66, 68 of the adhesive element 64 to provide electrical connection between the conductive layers of the mirror reflective element 16 and an electrical connector 70 that is disposed at or integrally formed with the socket element 52. The electrical connector 70 includes a lead-frame or electrically conductive portion 72, such as a pair of electrically conductive traces or wires or foils or plates, that may be over-molded or otherwise disposed at an insulating portion 74. The insulating portion 74 may be integrally formed with or attached to or comprise a part of the socket element 52. The lead-frame 72 includes a pair of connector portions or terminals 72a that electrically connect to the tabs 60, 62 at the mirror reflective element 16, and the connector portions 72a may be biased toward engagement with the tabs 60, 62. For example, the connector portions 72a may comprise spring tabs that flex when engaged with the tabs 60, 62 to maintain engagement between the connector portions 72a and the tabs 60, 62, such as when the mirror reflective element 16 is adhesively attached to the portion of the mirror casing 14 and/or the socket 52. Optionally, the connector portions 72a may comprise a spring-loaded extendable and retractable pin (or pogo pin) (such as by utilizing aspects of the electrical connections described in U.S. Pat. Nos. 10,446,563 and/or 9,878,669, and/or U.S. Publication No. US-2022-0089102, which are hereby incorporated herein by reference in their entireties).

The insulating portion 74 may include a sheath or cover portion that extends along the lead-frame 72 between the connector portions 72a and an electrical connector 76 that electrically connects to the vehicle wire harness when the mirror assembly is installed at the vehicle. Respective end portions of the insulating portion 74 may include openings or framed portions exposing the connector portions 72a to the tabs 60, 62 at the mirror reflective element 16. The sheath of the insulating portion 74 may include punch-outs and/or projections that attach the electrical connector 70 to the socket element 52 and/or the mirror casing 14. That is, the electrical connector 70 may be integrated into the socket element 52 to provide a relatively flat or slim electrical connector behind the mirror reflective element 16 within the mirror head 12.

The electrical connector 76 may be disposed at a rear side of the mirror casing 14 and at or near the receiving portion of the socket element 52 for electrically connecting the electrical connector 70, and thus the mirror reflective element 16, to the wire harness of the vehicle. Thus, the vehicle may plug into the back of the mirror, and the wire harness does not need to pass through the ball and socket joint to the interior of the mirror head. The electrical connector 70 and socket element 52 and mirror assembly may utilize characteristics of the mirror assemblies described in U.S. Pub. No. US-2023-0111985, which is hereby incorporated herein by reference in its entirety.

Integrating the electrical connector with the socket element may result in a quicker and simpler assembly process. For example, during assembly of the mirror having a one-ball mounting configuration (e.g., FIGS. 7A-7D), the wrap spring 54 may be pushed to the socket 52 having the integrated electrical connector 70, and the clip or base 36 may be screwed to the stay 32. During assembly of the mirror having a two-ball mounting configuration, the wrap spring 44 may be pushed to the socket 34 of the stay 32, the set screw 40 may be screwed to the stay 32, and the wrap spring 54 may be pushed to the socket to the socket 52 having the integrated electrical connector 70. The stay 32, the housing 14, the socket element 52, and the mirror reflective element 16 may be manually loaded. A machine (e.g., an assembly robot) may press the socket 52 onto the mounting arm 46 and drive the screw 58. A torque test may be performed. The adhesive tape 64 may attach to the glass 16 and attach the glass 16 to the housing 14. A wet out process may be performed to complete adhesion. Power may be applied to the mirror reflective element 16 to darken or tint the mirror reflective element 16, the mirror assembly may be marked and the mirror assembly may be unloaded, inspected, and packed.

Although shown as having connector portions 72a and an electrical connector 76 for electrically connecting the electrochromic mirror reflective element to the wiring harness of the vehicle and delivering power to the electrochromic mirror reflective element, it should be understood that aspects of the electrical connector integrated with the socket of the mirror head may be suitable for powering other components of the mirror head, such as a light emitter and/or camera of a driver monitoring system or occupant monitoring system, a video display screen, an accessory like a compass or garage door opener module, and the like. Further, data signals may be transmitted between the mirror head and a system of the vehicle (e.g., a central vehicle ECU remote from the mirror assembly) via a connector integrated with the socket of the mirror head, such as via a coaxial connector integrated with the socket. For example, control signals may be transmitted between the remote ECU and a video display screen at the mirror head, a camera or other sensor at the mirror head, and the like.

The interior mirror assembly may comprise a dual-mode interior rearview video mirror that can switch from a traditional reflection mode to a live-video display mode, such as is by utilizing aspects of the mirror assemblies and systems described in U.S. Pat. Nos. 11,242,008; 11,214,199; 10,442,360; 10,421,404; 10,166,924; 10,046,706 and/or 10,029,614, and/or U.S. Publication Nos. US-2024-0064274; US-2021-0162926; US-2021-0155167; US-2020-0377022; US-2019-0258131; US-2019-0146297; US-2019-0118717 and/or US-2017-0355312, which are all hereby incorporated herein by reference in their entireties. The video display screen of the video mirror, when the mirror is in the display mode, may display video images derived from video image data captured by a rearward viewing camera, such as a rearward camera disposed at a center high-mounted stop lamp (CHMSL) location, and/or video image data captured by one or more other cameras at the vehicle, such as side-mounted rearward viewing cameras or the like, such as by utilizing aspects of the display systems described in U.S. Pat. No. 11,242,008, which is hereby incorporated herein by reference in its entirety. The operating mode of the mirror and video display screen may be selected by flipping the mirror head upward or downward (e.g., via a toggle located at the mirror head) or responsive to another user input. When the mirror is operating in the mirror mode, the video display screen is deactivated and rendered covert by the mirror reflective element, and the driver views rearward via reflection of light incident at the mirror reflective element. When the mirror is operating in the display mode, the video display screen is operated to display video images that are viewable through the mirror reflective element by the driver of the vehicle.

The reflective element and mirror casing are adjustable relative to a base portion or mounting assembly to adjust the driver's rearward field of view when the mirror assembly is normally mounted at or in the vehicle. The mounting assembly may comprise a single-ball or single-pivot mounting assembly, whereby the reflective element and casing are adjustable relative to the vehicle windshield (or other interior portion of the vehicle) about a single pivot joint, or the mounting assembly may comprise other types of mounting configurations, such as a double-ball or double-pivot mounting configuration or the like. The socket or pivot element is configured to receive a ball member of the base portion, such as for a single pivot or single ball mounting structure or a double pivot or double ball mounting structure or the like (such as a pivot mounting assembly of the types described in U.S. Pat. Nos. 6,318,870; 6,593,565; 6,690,268; 6,540,193; 4,936,533; 5,820,097; 5,100,095; 7,249,860; 6,877,709; 6,329,925; 7,289,037; 7,249,860 and/or 6,483,438, which are hereby incorporated herein by reference in their entireties).

The mounting base includes an attaching portion that is configured to be attached to an interior surface of a vehicle windshield (such as to a mounting button or attachment element adhered to the interior surface of the vehicle windshield or such as to a headliner or overhead console of the vehicle). The mounting base may comprise a metallic ball portion or may comprise a molded (such as injection molded) polymeric mounting base or may be otherwise formed, depending on the particular application of the mirror assembly.

The mirror assembly may comprise any suitable construction, such as, for example, a mirror assembly with the reflective element being nested in the mirror casing and with a bezel portion that circumscribes a perimeter region of the front surface of the reflective element, or with the mirror casing having a curved or beveled outermost exposed perimeter edge around the reflective element and with no overlap onto the front surface of the reflective element (such as by utilizing aspects of the mirror assemblies described in U.S. Pat. Nos. 7,184,190; 7,274,501; 7,255,451; 7,289,037; 7,360,932; 7,626,749; 8,049,640; 8,277,059 and/or 8,529,108, which are hereby incorporated herein by reference in their entireties) or such as a mirror assembly having a rear substrate of an electro-optic or electrochromic reflective element nested in the mirror casing, and with the front substrate having a curved or beveled outermost exposed perimeter edge, or such as a mirror assembly having a prismatic reflective element that is disposed at an outer perimeter edge of the mirror casing and with the prismatic substrate having a curved or beveled outermost exposed perimeter edge, such as described in U.S. Pat. Nos. 9,827,913; 9,174,578; 8,508,831; 8,730,553; 9,598,016 and/or 9,346,403, and/or U.S. Des. Pat. Nos. D633,423; D633,019; D638,761 and/or D647,017, which are hereby incorporated herein by reference in their entireties (and with electrochromic and prismatic mirrors of such construction are commercially available from the assignee of this application under the trade name INFINITY™ mirror).

The mirror assembly may include user actuatable inputs operable to control any of the accessories of or associated with the mirror assembly and/or an accessory module or the like. For example, the mirror assembly may include touch sensitive elements or touch sensors or proximity sensors, such as the types of touch sensitive elements described in U.S. Pat. Nos. 5,594,222; 6,001,486; 6,310,611; 6,320,282; 6,627,918; 7,224,324 and/or 7,253,723, and/or U.S. Publication Nos. US-2014-0022390 and/or US-2014-0293169, which are hereby incorporated herein by reference in their entireties, or such as proximity sensors of the types described in U.S. Pat. Nos. 7,224,324; 7,249,860 and/or 7,446,924, and/or U.S. Publication No. US-2006-0050018, which are hereby incorporated herein by reference in their entireties, or such as membrane type switches, such as described in U.S. Pat. No. 7,360,932, which is hereby incorporated herein by reference in its entirety, or such as detectors and the like, such as the types disclosed in U.S. Pat. Nos. 7,255,451; 6,504,531; 6,501,465; 6,492,980; 6,452,479; 6,437,258 and/or 6,369,804, which are hereby incorporated herein by reference in their entireties, and/or the like.

Optionally, the user inputs or buttons may comprise user inputs for a garage door opening system, such as a vehicle based garage door opening system of the types described in U.S. Pat. Nos. 6,396,408; 6,362,771; 7,023,322 and/or 5,798,688, which are hereby incorporated herein by reference in their entireties. Optionally, the user inputs may also or otherwise comprise user inputs for a telematics system of the vehicle, such as, for example, an ONSTAR® system as found in General Motors vehicles and/or such as described in U.S. Pat. Nos. 4,862,594; 4,937,945; 5,131, 154; 5,255,442; 5,632,092; 5,798,688; 5,971,552; 5,924,212; 6,243,003; 6,278,377; and 6,420,975; 6,477,464; 6,946,978; 7,308,341; 7,167,796; 7,004,593; 7,657,052 and/or 6,678,614, and/or U.S. Pat. Pub. No. US-2006-0050018, which are all hereby incorporated herein by reference in their entireties.

The mirror assembly may include a camera or sensor and/or light emitter of a driver monitoring system and/or head and face direction and position tracking system and/or eye tracking system and/or gesture recognition system. Such head and face direction and/or position tracking systems and/or eye tracking systems and/or gesture recognition systems may utilize aspects of the systems described in U.S. Pat. Nos. 11,827,153; 11,780,372; 11,639,134; 11,582,425; 11,518,401; 10,958,830; 10,065,574; 10,017,114; 9,405, 120 and/or 7,914,187, and/or U.S. Publication Nos. US-2025-0329174; US-2024-0383406; US-2024-0190456; US-2024-0168355; US-2022-0377219; US-2022-0254132; US-2022-0242438; US-2021-0323473; US-2021-0291739; US-2020-0320320; US-2020-0202151; US-2020-0143560; US-2019-0210615; US-2018-0231976; US-2018-0222414; US-2017-0274906; US-2017-0217367; US-2016-0209647; US-2016-0137126; US-2015-0352953; US-2015-0296135; US-2015-0294169; US-2015-0232030; US-2015-0092042; US-2015-0022664; US-2015-0015710; US-2015-0009010 and/or US-2014-0336876, and/or International Publication Nos. WO 2026/019985 and/or WO 2025/231198, which are all hereby incorporated herein by reference in their entireties.

The interior-viewing camera may be disposed at the mirror head of the interior rearview mirror assembly and moves together and in tandem with the mirror head when the driver of the vehicle adjusts the mirror head to adjust his or her rearward view. The interior-viewing camera may be disposed at a lower or chin region of the mirror head below the mirror reflective element of the mirror head, or the interior-viewing camera may be disposed behind the mirror reflective element and viewing through the mirror reflective element. Similarly, the light emitter may be disposed at the lower or chin region of the mirror head below the mirror reflective element of the mirror head (such as to one side or the other of the interior-viewing camera), or the light emitter may be disposed behind the mirror reflective element and emitting light that passes through the mirror reflective element. The ECU may be disposed at the mirror assembly (such as accommodated by the mirror head), or the ECU may be disposed elsewhere in the vehicle remote from the mirror assembly, whereby image data captured by the interior-viewing camera may be transferred to the ECU via a coaxial cable or other suitable communication line. Cabin monitoring or occupant detection may be achieved via processing at the ECU of image data captured by the interior-viewing camera. Optionally, cabin monitoring or occupant detection may be achieved in part via processing at the ECU of radar data captured by one or more interior-sensing radar sensors disposed within the vehicle and sensing the interior cabin of the vehicle.

The coaxial cable provides bi-directional communication between the mirror head and the ECU that is located at the vehicle remote from the mirror head. For example, the coaxial cable may provide power from the ECU to the mirror head and may provide control signals or data to the mirror head, and may receive image data from the camera at the mirror head. The coaxial cable and electronic connection between the ECU and the mirror head may utilize aspects of the systems described in U.S. Pat. Nos. 10,567,705; 10,298,823; 10,099,614; 10,089,537; 9,900,490 and/or 9,609,757, which are hereby incorporated herein by reference in their entireties. Thus, the bi-directional coaxial cable may commonly carry (i) image data captured by the DMS camera from the mirror head to the ECU, (ii) control signals from the ECU to the mirror head (such as for controlling the camera and/or a light emitter and/or dimming circuitry of the mirror head), and (iii) electrical power from a DC power supply of (or connected to) the ECU to the mirror head.

Changes and modifications in the specifically described embodiments may be carried out without departing from the principles of the present invention, which is intended to be limited only by the scope of the appended claims as interpreted according to the principles of patent law.

1. A vehicular interior electrochromic rearview mirror assembly, the vehicular interior electrochromic rearview mirror assembly comprising:
a mirror head adjustable relative to mounting structure, wherein the mounting structure is configured to mount the vehicular interior electrochromic rearview mirror assembly at an interior portion of an interior cabin of a vehicle;
wherein the mirror head pivotally attaches at the mounting structure via a pivot joint, and wherein the pivot joint comprises (i) a socket of the mirror head and (ii) a ball member of the mounting structure that is received in the socket of the mirror head;
wherein the mirror head accommodates an electrochromic mirror reflective element;
wherein, with the vehicular interior electrochromic rearview mirror assembly mounted at the interior portion of the interior cabin of the vehicle, the mirror head is adjustable relative to the mounting structure by a driver of the vehicle to set a rearward view for the driver provided by the electrochromic mirror reflective element;
wherein the electrochromic mirror reflective element comprises (i) a front glass substrate having a first side and a second side separated by a thickness of the front glass substrate and (ii) a rear glass substrate having a third side and a fourth side separated by a thickness of the rear glass substrate;
wherein a transparent electrically conductive film is disposed at the second side of the front glass substrate and an electrically conductive film is disposed at the third side of the rear glass substrate, and wherein an electrochromic medium is disposed between the front glass substrate and the rear glass substrate and contacts the transparent electrically conductive film at the second side of the front glass substrate and the electrically conductive film at the third side of the rear glass substrate;
wherein electrically conductive contacts at the fourth side of the rear glass substrate are in electrical connection with respective ones of the transparent electrically conductive film at the second side of the front glass substrate of the electrochromic mirror reflective element and the electrically conductive film at the third side of the rear glass substrate of the electrochromic mirror reflective element;
wherein the electrochromic mirror reflective element attaches at an attachment portion of the mirror head;
wherein the socket comprises an electrical connector having connector portions configured to electrically connect to respective ones of the electrically conductive contacts at the fourth side of the rear glass substrate;
wherein the connector portions of the electrical connector connect to the respective electrically conductive contacts at the fourth side of the rear glass substrate when the electrochromic mirror reflective element is attached at the socket via each connector portion of the electrical connector being biased toward and engaging the respective electrically conductive contact;
wherein circuitry for at least in part controlling operation of the electrochromic mirror reflective element is disposed remote from the vehicular interior electrochromic rearview mirror assembly; and
wherein, with the vehicular interior electrochromic rearview mirror assembly mounted at the interior portion of the interior cabin of the vehicle and with the ball member of the mounting structure received in the socket of the mirror head, the electrical connector of the socket is electrically connected to a wire harness of the vehicle to electrically connect to the circuitry for at least in part controlling operation of the electrochromic mirror reflective element.

2. The vehicular interior electrochromic rearview mirror assembly of claim 1, wherein the electrical connector is integrally formed with the socket.

3. The vehicular interior electrochromic rearview mirror assembly of claim 2, wherein the electrical connector is insert molded with the socket.

4. The vehicular interior electrochromic rearview mirror assembly of claim 1, wherein the attachment portion of the mirror head comprises an inner surface of a mirror casing of the mirror head.

5. The vehicular interior electrochromic rearview mirror assembly of claim 4, wherein the electrochromic mirror reflective element is adhesively attached at the inner surface of the mirror casing of the mirror head via an adhesive element having (i) a first side that adhesively attaches at the inner surface of the mirror casing of the mirror head and (ii) a second side opposite the first side that adhesively attaches at the electrochromic mirror reflective element.

6. The vehicular interior electrochromic rearview mirror assembly of claim 1, wherein the attachment portion of the mirror head comprises a portion of the socket disposed within a mirror casing of the mirror head.

7. The vehicular interior electrochromic rearview mirror assembly of claim 1, wherein the attachment portion comprises an attachment plate that is adhesively attached at the fourth side of the rear glass substrate, and wherein the electrochromic mirror reflective element is attached at the socket via the attachment plate attaching at the socket, and wherein the attachment plate is snap-attached at a mirror casing of the mirror head to attach the electrochromic mirror reflective element at the attachment portion of the mirror head.

8. The vehicular interior electrochromic rearview mirror assembly of claim 1, wherein the connector portions of the electrical connector comprise spring-biased connector portions that are biased into engagement with the electrically conductive contacts at the rear side of the electrochromic mirror reflective element.

9. The vehicular interior electrochromic rearview mirror assembly of claim 1, wherein the mounting structure comprises (i) a base portion that attaches at the interior portion of the interior cabin of the vehicle and (ii) the ball member.

10. The vehicular interior electrochromic rearview mirror assembly of claim 9, wherein the ball member is integrally formed with the base portion.

11. The vehicular interior electrochromic rearview mirror assembly of claim 9, wherein the mounting structure comprises a mounting arm comprising (i) the ball member at a first end of the mounting arm and (ii) a second ball member at a second end of the mounting arm opposite the first end, wherein the second ball member is received at a socket of the base portion to adjustably mount the mounting arm and the mirror head relative to the base portion.

12. The vehicular interior electrochromic rearview mirror assembly of claim 1, wherein, with the vehicular interior electrochromic rearview mirror assembly mounted at the interior portion of the interior cabin of the vehicle and with the ball member of the mounting structure received in the socket of the mirror head, the electrical connector of the socket is electrically connected to the wire harness of the vehicle via a connector portion disposed at a rear side of a mirror casing of the mirror head.

13. The vehicular interior electrochromic rearview mirror assembly of claim 1, wherein no portion of the wire harness of the vehicle passes through the ball member of the mounting structure.

14. The vehicular interior electrochromic rearview mirror assembly of claim 1, wherein the ball member of the mounting structure comprises structure that, with the vehicular interior electrochromic rearview mirror assembly mounted at the interior portion of the interior cabin of the vehicle and with the ball member of the mounting structure received in the socket of the mirror head, engages corresponding structure of the socket to preclude the ball member of the mounting structure from pulling out of the socket of the mirror head.

15. The vehicular interior electrochromic rearview mirror assembly of claim 1, wherein controlling operation of the electrochromic mirror reflective element comprises controlling dimming of the electrochromic mirror reflective element.

16. A vehicular interior electrochromic rearview mirror assembly, the vehicular interior electrochromic rearview mirror assembly comprising:
a mirror head adjustable relative to mounting structure, wherein the mounting structure is configured to mount the vehicular interior electrochromic rearview mirror assembly at an interior portion of an interior cabin of a vehicle;
wherein the mounting structure comprises (i) a base portion that attaches at the interior portion of the interior cabin of the vehicle and (ii) a ball member;
wherein the base portion is configured to slidably receive a wedge disposed at the interior portion of the interior cabin of the vehicle;
wherein the mirror head comprises a mirror casing, and wherein the mirror casing comprises an aperture;
wherein the mirror head pivotally attaches at the mounting structure via a pivot joint, and wherein the pivot joint comprises (i) a socket of the mirror head attached at an inner potion of the mirror casing and (ii) the ball member of the mounting structure that is received in the socket of the mirror head through the aperture of the mirror casing;
wherein the mirror head accommodates an electrochromic mirror reflective element;
wherein, with the vehicular interior electrochromic rearview mirror assembly mounted at the interior portion of the interior cabin of the vehicle, the mirror head is adjustable relative to the mounting structure by a driver of the vehicle to set a rearward view for the driver provided by the electrochromic mirror reflective element;
wherein the electrochromic mirror reflective element comprises (i) a front glass substrate having a first side and a second side separated by a thickness of the front glass substrate and (ii) a rear glass substrate having a third side and a fourth side separated by a thickness of the rear glass substrate;
wherein a transparent electrically conductive film is disposed at the second side of the front glass substrate and an electrically conductive film is disposed at the third side of the rear glass substrate, and wherein an electrochromic medium is disposed between the front glass substrate and the rear glass substrate and contacts the transparent electrically conductive film at the second side of the front glass substrate and the electrically conductive film at the third side of the rear glass substrate;
wherein electrically conductive contacts at the fourth side of the rear glass substrate are in electrical connection with respective ones of the transparent electrically conductive film at the second side of the front glass substrate of the electrochromic mirror reflective element and the electrically conductive film at the third side of the rear glass substrate of the electrochromic mirror reflective element;
wherein the electrochromic mirror reflective element attaches at an attachment portion of the mirror head;
wherein the socket comprises an electrical connector having connector portions configured to electrically connect to respective ones of the electrically conductive contacts at the fourth side of the rear glass substrate;
wherein the connector portions of the electrical connector connect to the respective electrically conductive contacts at the fourth side of the rear glass substrate when the electrochromic mirror reflective element is attached at the socket via each connector portion of the electrical connector being biased toward and engaging the respective electrically conductive contact;
wherein circuitry for at least in part controlling operation of the electrochromic mirror reflective element is disposed remote from the vehicular interior electrochromic rearview mirror assembly; and
wherein, with the vehicular interior electrochromic rearview mirror assembly mounted at the interior portion of the interior cabin of the vehicle and with the ball member of the mounting structure received in the socket of the mirror head, the electrical connector of the socket is electrically connected to a wire harness of the vehicle to electrically connect to the circuitry for at least in part controlling operation of the electrochromic mirror reflective element.

17. The vehicular interior electrochromic rearview mirror assembly of claim 16, wherein the attachment portion of the mirror head comprises an inner surface of the mirror casing of the mirror head, and wherein the electrochromic mirror reflective element is adhesively attached at the inner surface of the mirror casing of the mirror head via an adhesive element having (i) a first side that adhesively attaches at the inner surface of the mirror casing of the mirror head and (ii) a second side opposite the first side that adhesively attaches at the electrochromic mirror reflective element.

18. The vehicular interior electrochromic rearview mirror assembly of claim 16, wherein the attachment portion comprises an attachment plate that is adhesively attached at the fourth side of the rear glass substrate, and wherein the electrochromic mirror reflective element is attached at the socket via the attachment plate attaching at the socket, and wherein the attachment plate is snap-attached at the mirror casing of the mirror head to attach the electrochromic mirror reflective element at the attachment portion of the mirror head.

19. A vehicular interior electrochromic rearview mirror assembly, the vehicular interior electrochromic rearview mirror assembly comprising:
a mirror head adjustable relative to mounting structure, wherein the mounting structure is configured to mount the vehicular interior electrochromic rearview mirror assembly at an interior portion of an interior cabin of a vehicle;
wherein the mounting structure comprises (i) a base portion that attaches at the interior portion of the interior cabin of the vehicle and (ii) a mounting arm;
wherein the mounting arm comprises (i) a first ball member at a first end of the mounting arm and (ii) a second ball member at a second end of the mounting arm opposite the first end;
wherein the mirror head pivotally attaches at the mounting structure via a pivot joint, and wherein the pivot joint comprises (i) a socket of the mirror head and (ii) the first ball member of the mounting structure that is received in the socket of the mirror head;
wherein the second ball member is received at a socket of the base portion to adjustably mount the mounting arm and the mirror head relative to the base portion;
wherein the first ball member of the mounting structure comprises a diameter that is less than or equal to 28 millimeters;
wherein the mirror head accommodates an electrochromic mirror reflective element;
wherein, with the vehicular interior electrochromic rearview mirror assembly mounted at the interior portion of the interior cabin of the vehicle, the mirror head is adjustable relative to the mounting structure by a driver of the vehicle to set a rearward view for the driver provided by the electrochromic mirror reflective element;
wherein the electrochromic mirror reflective element comprises (i) a front glass substrate having a first side and a second side separated by a thickness of the front glass substrate and (ii) a rear glass substrate having a third side and a fourth side separated by a thickness of the rear glass substrate;
wherein a transparent electrically conductive film is disposed at the second side of the front glass substrate and an electrically conductive film is disposed at the third side of the rear glass substrate, and wherein an electrochromic medium is disposed between the front glass substrate and the rear glass substrate and contacts the transparent electrically conductive film at the second side of the front glass substrate and the electrically conductive film at the third side of the rear glass substrate;
wherein electrically conductive contacts at the fourth side of the rear glass substrate are in electrical connection with respective ones of the transparent electrically conductive film at the second side of the front glass substrate of the electrochromic mirror reflective element and the electrically conductive film at the third side of the rear glass substrate of the electrochromic mirror reflective element;
wherein the electrochromic mirror reflective element attaches at an attachment portion of the mirror head;
wherein the socket of the mirror head comprises an electrical connector having connector portions configured to electrically connect to respective ones of the electrically conductive contacts at the fourth side of the rear glass substrate;
wherein the connector portions of the electrical connector connect to the respective electrically conductive contacts at the fourth side of the rear glass substrate when the electrochromic mirror reflective element is attached at the socket of the mirror head via each connector portion of the electrical connector being biased toward and engaging the respective electrically conductive contact;
wherein circuitry for at least in part controlling operation of the electrochromic mirror reflective element is disposed remote from the vehicular interior electrochromic rearview mirror assembly;
wherein, with the vehicular interior electrochromic rearview mirror assembly mounted at the interior portion of the interior cabin of the vehicle and with the first ball member of the mounting structure received in the socket of the mirror head, the electrical connector of the socket of the mirror head is electrically connected to a wire harness of the vehicle to electrically connect to the circuitry for at least in part controlling operation of the electrochromic mirror reflective element; and
wherein no portion of the wire harness of the vehicle passes through the first ball member of the mounting structure.

20. The vehicular interior electrochromic rearview mirror assembly of claim 19, wherein the first ball member of the mounting structure comprises structure that, with the vehicular interior electrochromic rearview mirror assembly mounted at the interior portion of the interior cabin of the vehicle and with the first ball member of the mounting structure received in the socket of the mirror head, engages corresponding structure of the socket to preclude the first ball member of the mounting structure from pulling out of the socket of the mirror head.
